(19) United States
(12) Patent Application Publication
(10) Pub. No.: US 2010/0139047 A1
(43) Pub. Date: Jun. 10, 2010

(54) Ergonomic Tool Handle Accessory

(76) Inventor: Konrad Eek, Norman, OK (US)

Correspondence Address: MATTHEW E. BURR, 620 CONGRESS AVENUE, STE 320, AUSTIN, TX, 78701, US

(21) Appl. No.: 12/631,465

(22) Filed: Dec. 4, 2009

Related U.S. Application Data
(60) Provisional application No. 61/120,398, filed on Dec. 6, 2008.

(51) Int. Cl. B25G 1/10; A46B 5/00; A47L 13/20; A01D 7/00

(52) U.S. Cl. 16/430; 15/159.1; 15/228; 56/400.17

(57) ABSTRACT

A handle accessory provides an attachment portion that attaches to a rod handle of a tool such as a mop or broom, and a grasping portion that projects out into space from the attachment portion. In a preferred embodiment, the grasping portion consists of two lengths of material that project from the attachment portion and meet to form an acute interior angle. That is, the attachment portion and the grasping portion form a triangle.

### CROSS REFERENCE TO RELATED APPLICATIONS

This application relates to, claims priority from and the benefit of co-pending provisional U.S. patent application entitled Cleaner Tool Handle Accessory, filed Dec. 6, 2008 and assigned Ser. No. 61/120,398, the disclosure of which is incorporated herein as if set forth in full.

### TECHNICAL FIELD

This disclosure relates generally to tool handles and more particularly to a tool handle accessory that renders holding a tool ergonomically comfortable and improves the effectiveness of the tool.

### BACKGROUND

Household tools such as mops, brooms and rakes often consist of a long rod handle with a tool implement such as a mop head, bristles or teeth attached to one end of the rod. The free end of the handle is used to grasp the tool by the handle and wield it for its intended purpose such as cleaning the floor or raking leaves.

Grasping the handle with both hands allows the hand nearest the tool head to act as a fulcrum so that leverage can be applied with the other hand to create a force that is applied by the tool head onto the surface being worked by the tool. That is, the mop head applies a force to the floor that is being cleaned. It would be advantageous, therefore, to provide an accessory that can be selectively mounted on the tool handle that allows comparable or even greater force to be applied by the tool and which accessory further has the advantage of providing a more ergonomically comfortable handle than is the unaccessorized rod handle of the tool.

### SUMMARY

The present disclosure describes a handle accessory which provides an attachment portion that attaches to the rod handle of the tool and a grasping portion that projects out into space from the attachment portion. In a preferred embodiment, the grasping portion consists of two lengths of material that project from the attachment portion and meet to form an acute interior angle. That is, the attachment portion and the grasping portion form a triangle.

In operation, a user grasps the rod handle of the tool with one hand and grasps the grasping portion of the present accessory with the other hand and applies force to the head of the tool accordingly. The projection of the grasping portion out from the tool handle rod provides an ergonomically comfortable hold that suits the natural angle of the human wrist.

### BRIEF DESCRIPTION OF THE DRAWINGS

For a more complete understanding of the present disclosure, and the advantages thereof, reference is now made to the following description taken in conjunction with the accompanying drawings, in which:

FIG. 1 is a side view of a tool handle accessory of the present disclosure.

FIG. 2 is a side view of a tool handle accessory of the present disclosure illustrating a preferred manner of operation.

### DETAILED DESCRIPTION

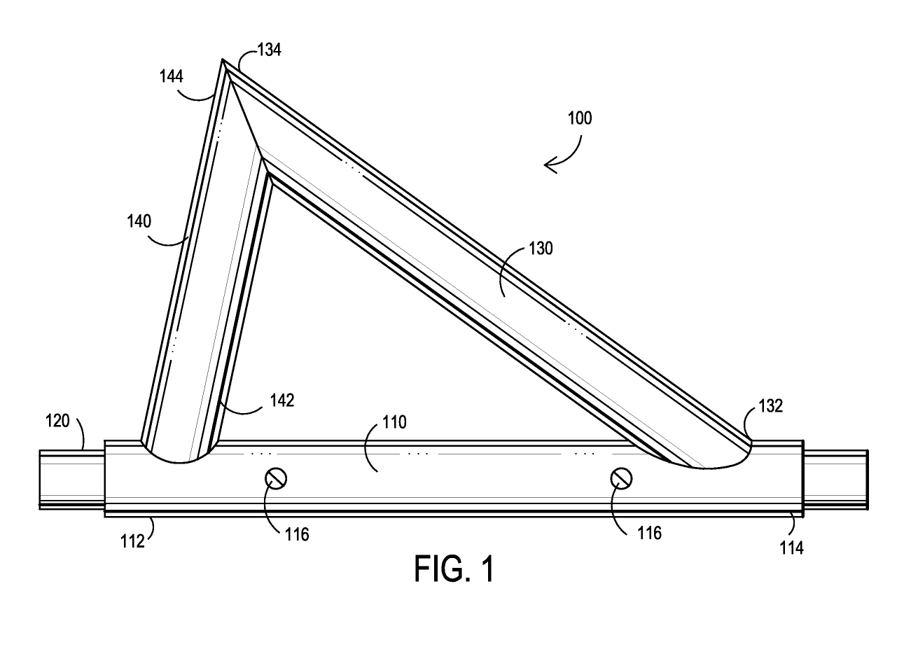

FIG. 1 is a side view of a tool handle accessory of the present disclosure. Referring to FIG. 1 of the drawings, the reference numeral 100 generally designates a tool handle accessory embodying features of the present disclosure. Accessory 100 includes an attachment portion 110 having a top end 112 and a bottom end 114 proximate to the tool head (not shown) attached to tool rod handle 120. One or more attachment means 116 fasten accessory 100 to rod 120. It will be understood by those skilled in the art that any suitable attachment means may be employed to achieve the objects of the present disclosure. Examples of fasteners include without limitation screws, nails, glue, epoxy, threads, bolts, pins, rivets, welds and friction mounting. Alternative embodiments contemplate plastic or other synthetic tool handles that incorporate a structure of the present accessory integrally manufactured. The means of attachment that is selected for any particular embodiment may depend on the material composition of the tool handle rod to which the accessory is attached.

Support leg 130 projects out obliquely from attachment portion 100 at bottom end 114 designated by the junction 132. At distal junction 134/144, support leg 130 meets grasping arm 140.

Grasping arm 140 projects obliquely from the top 112 of attachment portion 110 at the junction 142 and meets support leg 130 at junction 144/134.

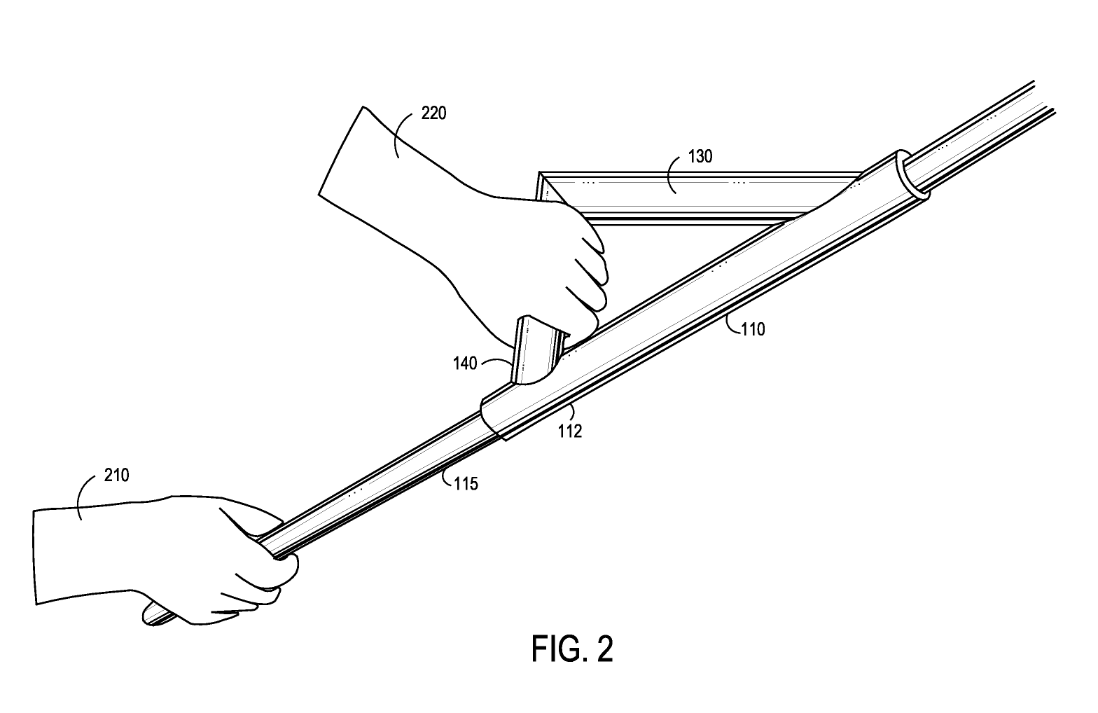

FIG. 2 is a side view of a tool handle accessory of the present disclosure illustrating a preferred manner of operation. A user grasps with one hand 210 tool rod handle 115 above top 112 of attachment portion 112 and grasps accessory 100 with the other hand 220 at grasping arm 140.

In operation, a user grasps the rod handle of the tool with one hand and grasps the grasping portion of the present accessory with the other hand and applies force to the head of the tool accordingly. The extension of the grasping portion out from the tool handle rod provides and ergonomically comfortable hold that suits the natural angle of the human wrist.

In a preferred embodiment attachment portion 110 comprises a tube through which rod 115 can be inserted so that accessory 100 may be positioned anywhere along the length of rod 115 that a user desires and then fastened at the desired location as described above.

An alternative embodiment provides an accessory having a grasping arm that projects perpendicular rather than obliquely from the attachment portion.

The use of a handle accessory 100 of the present disclosure provides many advantages over the prior art including without limitation that the mop head, or other tool head such as a broom bristle or yard rake tongs, for example, applies a force to the floor that is being cleaned. Accessory 100 can be selectively mounted on the tool handle that allows comparable or even greater force to be applied by the tool and which accessory further has the advantage of providing a more ergonomically comfortable handle than is the unaccessorized rod handle 115 of the tool.

Accessory 100 may be fabricated from any suitably strong and durable material including without limitation, plastic, metal, composite, wood or some combination of materials.

Many modifications and other embodiments of the handle accessory described herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An accessory for tool handles having a rod, the accessory comprising:
an attachment portion to attach the accessory to the rod; and
a grasping portion that projects from the attachment portion.

2. The accessory of claim 1 wherein the attachment portion has a top end and a bottom end and wherein the grasping portion further comprises a support leg projecting obliquely from the bottom of the attachment portion and a grasping arm projecting from the top of the attachment portion such the support leg and the grasping arm meet at a junction.

3. The accessory of claim 1 wherein the accessory is selectively mounted on the rod of tool handle.

4. The accessory of claim 1 wherein the accessory is integral to the tool handle rod.

5. The accessory of claim 1, wherein the tool comprises a mod.

6. The accessory of claim 1, wherein the tool comprises a broom.

7. The accessory of claim 1, wherein the tool comprises a garden rake.

8. An accessory for tool handles having a rod, the accessory comprising:
an attachment portion to attach the accessory to the rod and wherein the attachment portion has a top end and a bottom end; and
a grasping portion that projects from the attachment portion wherein the grasping portion further comprises a support leg projecting obliquely from the bottom of the attachment portion and a grasping arm projecting from the top of the attachment portion such the support leg and the grasping arm meet at a junction.
